(19) United States
(12) Patent Application Publication
(10) Pub. No.: US 2026/0001080 A1
(43) Pub. Date: Jan. 1, 2026

(54) GAP WIDTH MONITORING

(71) Applicant: Cellwood Machinery AB, NÄSSJÖ (SE)

(72) Inventors: Christian Jonasson, Landvetter (SE); Sobhan Sepehri, Göteborg (SE); Christer Johansson, Göteborg (SE); Stefan Virtanen, Nässjö (SE)

(21) Appl. No.: 19/132,775

(22) PCT Filed: Nov. 29, 2023
(86) PCT No.: PCT/SE2023/051204

§ 371 Date: May 23, 2025

(30) Foreign Application Priority Data
Dec. 2, 2022 (SE) 2251404-6

(51) Int. Cl. B02C 7/14; D21D 1/30

(52) U.S. Cl. CPC B02C 7/14; D21D 1/306

(57) ABSTRACT

The present disclosure relates to a method of monitoring a width (w) of a gap (1) between two grinding discs (2) in a grinding device (10) for processing a fibrous fluid (6). The method comprises rotating a first disc of the grinding discs relative to a second disc of the grinding discs, about a rotational axis of the first disc. The method also comprises obtaining a frequency spectrum of mechanical vibrations in the grinding device caused by the rotating of the first disc relative to the second disc. The method also comprises, within a predetermined frequency range of the obtained frequency spectrum, determining a prevalence of vibration peaks, said prevalence being an indication of the gap width.

### TECHNICAL FIELD

The present disclosure relates to monitoring of a width of a gap between two grinding discs in a grinding device for processing a fibrous fluid.

### BACKGROUND

Within the paper industry, devices such as dispersers, refiners and deflakers are used for processing the pulp in liquid dispersion form. The fluid pulp is pressed between two grinding discs rotating relative to each other about a rotational axis. The gap width between the discs, i.e. the axial distance between the discs, affect the efficiency of the processing. There is thus a need to set a suitable gap width during operation.

Traditionally, a suitable gap width is set by, prior to operation, while the grinding discs are rotating, axially pushing the discs towards each other, the resulting sound heard by an operator defining a zero or minimum gap width. From that minimum, the discs may then be axially separated by a desired amount, after which grinding can commence. A disadvantage is that the gap width is then not monitored during operation, and there is a need for periodically discontinuing operation to recalibrate, find the minimum. Recalibration is typically needed since the grinding discs are worn during operation, affecting both the minimum and the processing efficiency at a given gap width.

US 2022/0098790 discloses a pulp grinding device in which, in order to determine the minimum distance between the base plates, the mechanical oscillations are detected on the device and the distance between the base plates rotating relative to one another is reduced until the frequency and/or the amplitude and/or the change in frequency and/or the change in amplitude of the oscillations exceeds a limit value.

WO 2022/043363) discloses sensing vibrations caused by two treatment tools rotating in relation to each other with a treatment gap there between. The vibration intensity within the frequency range of 5-12 kHz is measured over time. When a threshold for the vibration intensity is exceeded, this indicates that the treatment tools are in contact with each other, and the treatment gap can be increased to prevent further such contact. To avoid false positives, intensity measurements can be performed at several successive time intervals.

US 2007/125891 similarly discloses measuring axial vibrations over time of a pulp refiner. At a time when the measured vibrations indicate that the plates are clashing, the pulp flow is increased or the plates are moved further apart.

### SUMMARY

It is an objective of the present invention to provide monitoring of gap width in a grinding device during operation thereof.

According to an aspect of the present invention, there is provided a method of monitoring a width of a gap between two grinding discs in a grinding device for processing a fibrous fluid. The method comprises rotating a first disc of the grinding discs relative to a second disc of the grinding discs, about a rotational axis of the first disc. The method also comprises obtaining a frequency spectrum of mechanical vibrations in the grinding device caused by the rotating of the first disc relative to the second disc. The method also comprises, within a predetermined frequency range of the obtained frequency spectrum, determining a prevalence of vibration peaks, said prevalence being an indication of the gap width.

According to another aspect of the present invention, there is provided a controller comprising processing circuitry, and storage storing instructions executable by said processing circuitry whereby said controller is operative to perform an embodiment of the method of the present disclosure.

According to another aspect of the present invention, there is provided a grinding device comprising an embodiment of the controller of the present disclosure, and the first and second grinding discs.

According to another aspect of the present invention, there is provided a computer program product comprising computer-executable components for causing a controller to perform an embodiment of the method of the present disclosure when the computer-executable components are run on processing circuitry comprised in the controller.

By obtaining a frequency spectrum of the mechanical vibrations and determining the prevalence of vibration peaks in the frequency spectrum, in frequency domain, e.g. determining how many peaks above a predetermined vibration amplitude (energy) are present within a predetermined frequency range of the frequency spectrum, an indication of the gap width is provided. A smaller gap width leads to a higher prevalence of vibration peaks, indicating tougher processing of the fibrous fluid, e.g. pulp. A desired prevalence of the vibration peaks may e.g. be known from prior operation of the grinding device, typically with the same type of grinding discs.

By studying vibration peaks in frequency domain, rather than in time domain, the gap width can be monitored, not merely whether the discs are contacting (hitting) each other. According to the present invention, the prevalence of vibration peaks in frequency domain in the frequency spectrum is determined. For example, the prevalence can be defined by the number of vibration peaks within a predetermined frequency range of the frequency spectrum, or by an average distance between adjacent vibration peaks within the frequency range. Thus, the prevalence can be regarded as a density of vibration peaks at respective different frequencies in the frequency spectrum.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic side view in longitudinal section of a grinding device, in accordance with some embodiments of the present invention.

FIG. 2 is a schematic block diagram of a grinding device, in accordance with some embodiments of the present invention.

FIG. 3 is a schematic block diagram of a controller, in accordance with some embodiments of the present invention.

FIG. 4 is a schematic flow chart of some embodiments of the method of the present invention.

FIG. 5 is a schematic example of a frequency spectrum of mechanical vibrations and prevalence of vibration peaks, in accordance with some embodiments of the present invention.

FIG. 6 is a schematic graph illustrating an example of prevalence of vibration peaks as a function of gap width, in accordance with some embodiments of the present invention.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

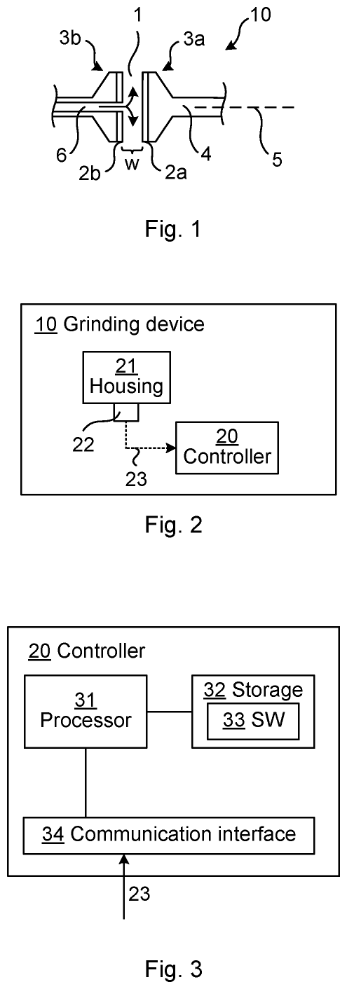

FIG. 1 illustrates a grinding device 10, e.g. a disperser, refiner or deflaker. The griding device is configured for processing a fibrous fluid, e.g. a liquid with fibres suspended therein (i.e. a liquid suspension), such as pulp for paper production or bio-slurry. In case of paper pulp, the fibrous fluid may comprise cellulose fibres. Thus, in some embodiments, the fibres in the fibrous fluid comprises or consists of cellulose.

The grinding device 10 comprises first and second grinding discs 2a and 2b arranged to rotate relative to each other about a rotational axis 5. Typically, the first and second grinding discs 2a and 2b are arranged in respective planes parallel to each other, and each arranged rotation symmetrically with a line of symmetry corresponding to the rotational axis 5. For instance, the first grinding disc 2a may be comprised (e.g. mounted) in a rotor 3a arranged to rotate about the rotational axis 5, while the second grinding disc 2b may be comprised (e.g. mounted) in a stator 3b arranged to be stationary while the rotor 3a rotates. A gap 1 is formed between the first and second discs 2a and 2b, having a gap width w defined by the axial distance between said discs (or between the respective parallel planes in which the discs are arranged). During operation, the fibrous fluid 6 is processed by being pressed through the gap 1 between the grinding discs 2a and 2b while the discs are rotating relative to each other. For instance, as shown in the figure, the fibrous fluid 6 may be introduced into the gap 1 from an axial inlet, e.g. formed in the stator 3b, whereby the fluid 6 is processed by the grinding discs 2a and 2b in the gap 1 as it flows from the axial inlet to the periphery of the discs, as illustrated by the arrows in the gap 1 in the figure.

The gap width w can be adjusted by axially shifting at least one of the grinding discs 2a and 2b, e.g. by axially moving the rotor 2a either towards the stator 2b, reducing the gap width w, or away from the stator 2b, increasing the gap width w. However, the actual gap width w (i.e. distance between the discs, in millimetres or other unit of length) may be difficult to know based only on the axial position of the rotor 3a, e.g. since the thickness of the grinding discs 2a and 2b may vary by design or wear.

FIG. 2 illustrates a grinding device 10, e.g. a grinding device in accordance with FIG. 1. The grinding device comprises a vibration sensor 22 for sensing mechanical vibrations in the grinding device, resulting from the rotating of the discs relative to each other. By means of the vibration sensor 22, the vibration frequency spectrum can be obtained. The vibration sensor may comprise an accelerometer, but any other vibration sensor may additionally or alternatively be used, e.g. comprising a laser vibrometer. The grinding device 10 may comprise a housing 21, at least partly enclosing the first and second grinding discs 2a and 2b, e.g. at least partly enclosing the rotor 2a and the stator 2b. Mechanical vibrations resulting from the rotating of the discs relative to each other, e.g. while the fluid 6 is pressed through the gap 1, may propagate to the housing. Thus, the vibration sensor 22 may conveniently be arranged to sense vibrations in the housing 21, e.g. by being mounted onto the housing 21, especially if the vibration sensor 22 comprises an accelerometer.

The grinding device 10 may also comprise a controller 20 for controlling the operation of the grinding device. In some embodiments, the controller 20 controls the rotational speed of the grinding disc(s), as well as any axial shifting of the disc(s). The controller 20 may e.g. send control signals for rotating the first disc 2a about its rotational axis 5. For instance, the controller 20 may receive a signal 23 from the sensor 22, from which signal 23 the controller 22 may obtain the frequency spectrum. From the vibration frequency spectrum, the controller may also determine the prevalence of vibration peaks. In some embodiments, the controller may control a user interface, e.g. for communicating with, or presenting information to, a user/operator of the grinding device 10, e.g. a human user.

FIG. 3 illustrates a controller 20. The controller 20 comprises processing circuitry 31 e.g. a central processing unit (CPU). The processing circuitry 31 may comprise one or a plurality of processing units in the form of microprocessor(s). However, other suitable devices with computing capabilities could be comprised in the processing circuitry 31, e.g. an application specific integrated circuit (ASIC), a field programmable gate array (FPGA) or a complex programmable logic device (CPLD). The processing circuitry 31 is configured to run one or several computer program(s) or software (SW) 33 stored in a storage 32 of one or several storage unit(s) e.g. a memory. The storage unit is regarded as a computer readable means 32, forming a computer program product together with the SW 33 stored thereon as computer-executable components, and may e.g. be in the form of a Random Access Memory (RAM), a Flash memory or other solid state memory, or a hard disk, or be a combination thereof. The processing circuitry 31 may also be configured to store data in the storage 32, as needed. The controller 20 may also comprise a communication interface 23, e.g. for receiving the sensor signal 23 from the vibration sensor 22.

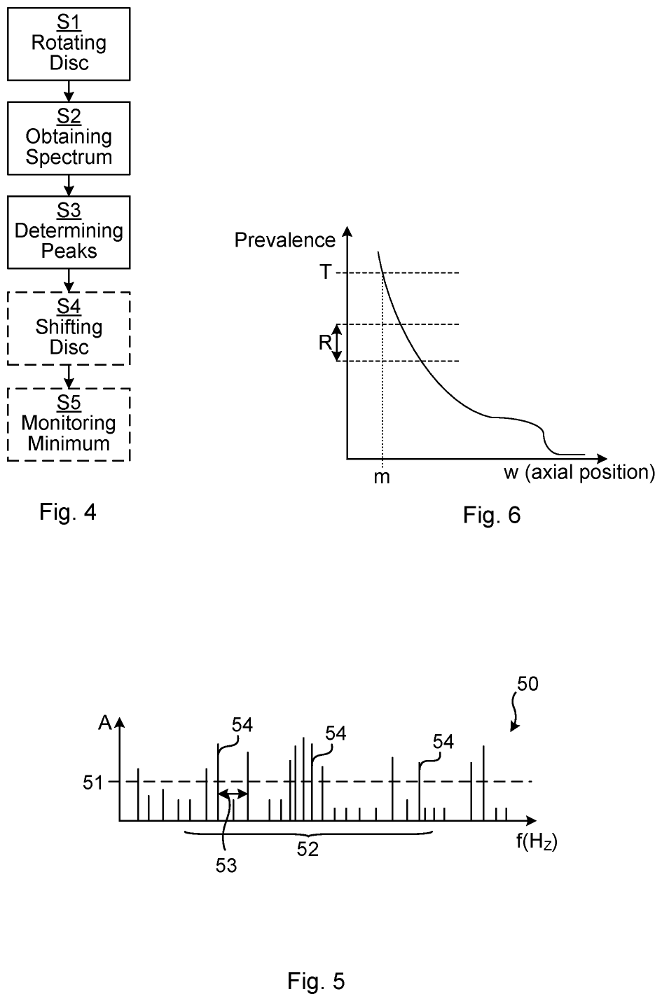

FIG. 4 illustrates some embodiments of the method of the present disclosure. The method is for monitoring a width w of a gap 1 between two grinding discs 2 in a grinding device 10 for processing a fibrous fluid 6. The method comprises rotating S1 a first disc 2a of the grinding discs relative to a second disc 2b of the grinding discs, about a rotational axis 5 of the first disc. The method also comprises obtaining S2 a frequency spectrum 50 of mechanical vibrations in the grinding device 10 caused by the rotating S1 of the first disc 2a relative to the second disc 2b. The method also comprises, within a predetermined frequency range 52 of the obtained S2 frequency spectrum 50, determining S3 a prevalence of vibration peaks 54, said prevalence being an indication of the gap width w. In some embodiments of the present invention, the method further comprises, during the rotating S1, shifting S4 at least one of the first and second discs 2 along the rotational axis 5. In some embodiments, the shifting S4 is to gradually reduce the gap width w until the determined S3 prevalence exceeds a predetermined prevalence threshold T, defining a minimum m of the gap width. In some embodiments, the method may then comprise monitoring S5 a variation of the minimum over time, the variation indicating progressive wear of the first and/or second disc 2. In some other embodiments, the shifting S4 is to adjust the gap width w such that the determined S3 prevalence is kept within a predetermined prevalence range R.

FIG. 5 illustrates a vibration frequency spectrum 50. The frequency spectrum may present the amplitude (energy) of vibrations at different frequencies, i.e. in frequency domain rather than time domain, e.g. with frequency f on the X-axis and vibration amplitude A on the Y-axis, as in the figure, at any given time or time period. The frequency spectrum comprises or consists of mechanical vibrations in the grinding device 10, e.g. a housing 21 thereof, caused by the rotating S1 of the first disc 2a relative to the second disc 2b. For instance, the mechanical vibrations may be measured, e.g. by means of the sensor signal 23 obtained S2 from the vibration sensor 22, over time (during a predetermined time period). Then, frequency analysis may be performed on the data of the measured vibrations to obtain the frequency spectrum 50. The mechanical vibrations depend on the gap width, as discussed herein, but also on e.g. rotation speed of the rotor 3a, number of teeth in the grinding discs 2a and 2b as well as configuration and/or wear of said teeth.

From the frequency spectrum 50, vibration peaks 54 at respective frequencies may be determined, where at a vibration peak a specific frequency is defined as such if the vibration amplitude A at said specific frequency exceeds a predetermined threshold 51. The frequency resolution, separating vibrations at different frequencies from each other may be pre-determined, e.g. depending on sample frequency and sample time (i.e. the number of samples).

When determining S3 the prevalence of vibration peaks 54 in the frequency spectrum 50, the vibration peaks within a predetermined frequency range 52 may be considered. The prevalence may be regarded as a density of vibration peaks, in frequency domain, in the frequency spectrum, i.e. the number of peaks at respective different frequencies per a predetermined frequency range of the frequency spectrum. In some embodiments, the prevalence of vibration peaks 54 is defined by the number of vibration peaks within the frequency range 52. Additionally or alternatively, in some embodiments, the prevalence of vibration peaks 54 is defined by the average distance 53 between adjacent vibration peaks 54 within the frequency range 52. Since the average distance 53 between peaks 54 within the range 52 depends on the number of peaks 54 within the range 52, whether to consider the number of peaks 54 and/or the average distance 53 between said peaks 54 may merely be a matter of which is easier to analyse.

FIG. 6 illustrates an example of determined S3 prevalence of, e.g. number of, vibration peaks 54 as a function of gap width w, e.g. measured as axial position of one of the grinding discs 2a and 2b, e.g. as the axial position of the rotor 3a. Generally, the prevalence increases with reduced gap width w. A minimum gap width m may be defined, so called zeroing, when the prevalence exceeds a predetermined prevalence threshold T. Thus, the gap width w may be reduced by axially shifting S4 one of the grinding discs 2a towards the other grinding disc 2b until the determined S3 prevalence exceeds the predetermined prevalence threshold T, whereby the minimum m of the gap width w is defined.

In some embodiments, it may be desirable to keep the prevalence of vibration peaks 54 relatively constant during operation of the grinding device 10, and to adjust the gap width w, typically by axially shifting S4 one of the discs as needed, to achieve this. Thus, in some embodiments, one of the discs may be axially shifted S4 to adjust the gap width w such that the determined S3 prevalence is kept within a predetermined prevalence range R. For example, in some embodiments during operation of the grinding device 10, the grinding disc 2a may be axially shifted S4 from a defined minimum m gap width w to an operation gap width defined by the prevalence of vibration peaks 54 being within the prevalence range R. The prevalence at the operation gap width may vary, e.g. be reduced, over time, e.g. due to wear of the grinding discs, why axial shifting S4, e.g. axially moving the rotor 3a towards the stator 3b, during operation to keep the prevalence within the prevalence range R.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. A method of monitoring a width of a gap between two grinding discs in a grinding device for processing a fibrous fluid, performed by a controller, the method comprising:
rotating a first disc of the grinding discs relative to a second disc of the grinding discs, about a rotational axis of the first disc;
obtaining a frequency spectrum of mechanical vibrations in the grinding device caused by the rotating of the first disc relative to the second disc;
within a predetermined frequency range of the obtained frequency spectrum, determining a prevalence of vibration peaks, the prevalence being a density of vibration peaks, in frequency domain, in the frequency spectrum, said prevalence being an indication of the gap width.

2. The method of claim 1, wherein each of the vibration peaks in the frequency spectrum is defined as a vibration peak at a specific frequency of said peak by exceeding a predetermined vibration amplitude threshold at said specific frequency.

3. The method of claim 1, wherein the prevalence of vibration peaks is defined by a number of vibration peaks within the frequency range, or by an average distance between adjacent vibration peaks within the frequency range.

4. The method of claim 1, further comprising:
during the rotating, shifting at least one of the first and second discs along the rotational axis to:
gradually reduce the gap width until the determined prevalence exceeds a predetermined prevalence threshold, defining a minimum of the gap width; or
adjust the gap width such that the determined prevalence is kept within a predetermined prevalence range.

5. The method of claim 4, further comprising:
monitoring a variation of the minimum over time, the variation indicating progressive wear of the first and/or second disc.

6. The method of claim 1, wherein the frequency spectrum is obtained by means of a vibration sensor, e.g. comprising an accelerometer.

7. The method of claim 6, wherein the vibration sensor is arranged to measure vibrations of a housing of the grinding device.

8. The method of claim 1, wherein the frequency spectrum is obtained while passing the fibrous fluid through the gap.

9. The method of claim 8, wherein the fibrous fluid is pulp or bio-slurry.

10. The method of claim 8, wherein fibres in the fibrous fluid comprises or consists of cellulose.

11. A controller comprising:
processing circuitry; and
storage storing instructions executable by said processing circuitry whereby said controller is operative to perform the method of claim 1 in a grinding device comprising two grinding discs.

12. A grinding device comprising:
the controller of claim 11; and
the first and second grinding discs.

13. The grinding device of claim 12, wherein the grinding device is a disperser, refiner or deflaker.

14. A computer program product comprising computer-executable components for causing a controller to perform the method of any claim 1 when the computer-executable components are run on processing circuitry comprised in the controller in a grinding device comprising two grinding discs.
